(19) United States
(12) Patent Application Publication
(10) Pub. No.: US 2019/0055742 A1
(43) Pub. Date: Feb. 21, 2019

(54) Direct image transfer repair

(71) Applicant: JERRY E. BROWER, VANCOUVER, WA (US)

(72) Inventor: JERRY E. BROWER, VANCOUVER, WA (US)

(21) Appl. No.: 15/731,851

(22) Filed: Aug. 16, 2017

(51) Int. Cl. E04G 23/02; G06K 15/02; B32B 7/12

(52) U.S. Cl. CPC E04G 23/0214; E04G 23/0285; B41J 2/01; B32B 7/12; G06K 15/02

(57) ABSTRACT

A method for repairing surface damage includes taking an image of a non-damaged area of the surface, selecting a repair patch having an outward surface adapted to be directly printable using an Ink Jet, Laser, or other household printer; printing the image onto the repair patch, and applying the repair patch over the damaged area. This repair method may use a patch with a self-adhesive lower surface for easy application. This method can further include placing a center reinforcement patch over the surface damage before applying the repair patch. The Center reinforcement patch may provide an adhesive on the lower surface.

This application is a divisional of U.S. Provisional Application Ser. No. 61/755,947 filed on Jan. 23, 2013 which priority is claimed. Applications are herein are incorporated by reference for all purposes.

### BACKGROUND OF THE INVENTION

This invention relates generally to repair patches and methods for repairing of various surfaces including but not limited to: exterior and interior brick, block, concrete, stucco, wood siding, metal siding, vinyl siding, hot tub covers, hardi-plank siding, gutters, laminate, metal roofs, texture on ceilings and walls, wallpaper, vinyl flooring, wood flooring, paneling, doors, cabinets, furniture, appliances, automotive and recreational vehicle, etc., and more specifically a self adhesive direct image transfer repair patch which results in a visually matching repair.

It is difficult at best to repair a hole in a surface such as vinyl siding. The only repair method currently available would be to remove the damaged piece and replace it. This same scenario applies to many other surface materials as well. Plus due to fading from the sun or other sources, it is difficult to have surface materials match after replacing a section.

Moreover, it frequently happens that a pattern of surface covering material such as wallpaper, vinyl flooring, laminate, etc. has become obsolete. This makes repairing surface damage impossible. This results in a repair method even more complex. Specifically, to repair a hole, in an area of obsolete surface material encompasses the removal of the surface material and a replacement piece of material must be cut to match the exact size of the removed area. The replacement material is placed within the cutout area and is adhered with the required adhesive for the specific material. The entire area must be cleaned and prepped to match the surrounding surface in order to result in a good repair.

In addition to the complexity, time, and number of materials required, by the prior art methods, the repair areas of the prior art are often conspicuous following the repair. Generally, prior art repair areas protrude noticeably from the surface of the surrounding surface. It is also difficult to match the texture, pattern and color of the repaired area with that of the surrounding surface.

What is needed, therefore, is a repair system that avoids the need for expensive tools, and repair materials. The industry would also be benefited by a repair method that substantially reduces the number of steps, the expertise, and the amount of time required to repair a tear, hole, or crack. The industry would further be benefited by a repair system and method that more easily matches the surrounding surface colors, patterns, textures and provides a less noticeable repair area.

### SUMMARY OF THE INVENTION

According to the needs of the industry, one object of the present invention is to enable a repair system that eliminates the need for expensive repair tools and replacement materials.

Another object of the present invention is to enable a repair system that provides an inconspicuous repair area.

Yet another object of the present invention is to enable a person to simply and reliably repair a variety of different surfaces with a visually identical match patch.

This invention provides a significant improvement in the art by enabling a self-adhesive repair patch that can be printed directly resulting in a visual match to the surrounding surface in color, pattern and texture. Without the time and expense associated with replacing the damaged surface material. A repair patch that according to the invention includes a substantially planar body having an inward surface and an outward surface. The body can be circular, rectangular, arranged in a strip, be cut or configured in any other desirable shape. The outer perimeter of the body may further come with a feathered, uneven or jagged edge in order to help it blend into the surrounding surface. A preferred shape for many applications is circular or oval. The body is preferably formed from a tough, stretch and tear resistant material. The inward surface of the body comprises or accepts an adhesive to adhere to the repair surface. The outward surface of the patch is directly printable using a standard household printer. The outward surface may further compromise an embossed or textured surface to match the surrounding area.

In one embodiment, the repair patch is made of thin, flexible material such as a thin plastic film, polypropylene, polyester, fibered paper, or other similar material. The material can be tough and both tear-and stretch-resistant. The repair patch of this embodiment can be applied directly over a hole, crack, or tear on the damaged surface. It can then be sealed if used in an exterior application. The repair patch can be combined with a smaller center reinforcement patch for added strength when covering large holes and gaps. The center reinforcement patch can be formed of a thicker, more rigid material such as sheet metal or thermoplastic, or from the same material as the repair patch as previously described. In this case the center reinforcement patch is installed, but is then covered with the flexible, thin repair patch having a directly printable, and possibly textured or embossed, outward surface.

### BRIEF DESCRIPTION OF THE DRAWINGS

The foregoing and other objects, features and advantages of the invention will become more readily apparent from the following detailed description of several embodiments of the invention which proceeds with reference to the accompanying drawings, in which:

FIG. 1A is a schematic top plan view of a match patch and adhesive backer according to a first embodiment of the present invention.

FIG. 1B is a cross-sectional view of a portion of the match patch and backer of FIG. 1A.

FIG. 2 is a schematic perspective view of a surface repair area illustrating a method of repair using the match patch of FIG. 1A, according to another aspect of the invention.

FIG. 3 is a schematic perspective view of a repair area illustrating a method of crack or tear repair using the match patch 1A.

FIG. 4 is a schematic perspective view of a patterned surface repair area illustrating an already printed on image transfer repair patch.

### DETAILED DESCRIPTION

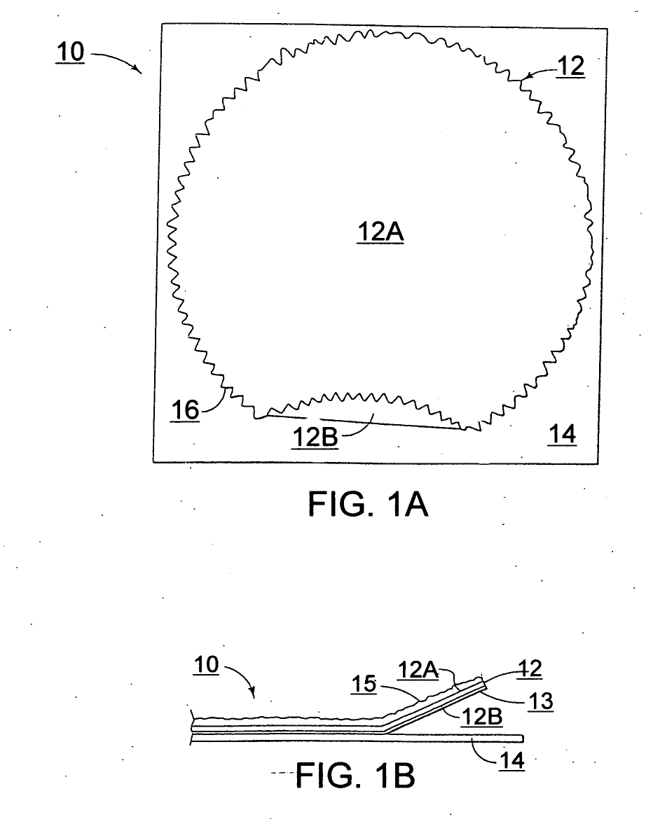

Referring to FIGS. 1A and 1B, a match patch 10 according to a first embodiment of the invention has a thin, substantially planar body 12. The body 12 can be formed of any thin, plastic, polypropylene, polyester film, fibered-paper, or similar material. Preferably, the material should be fairly strong (i.e., high tensile strength and low elasticity) and be resistant to both punctures and tears. The material can receive images on the first upper surface 12A from a standard household laser, ink jet or other printer. The image layer is shown in FIG. 1B 15. Presently, the most preferred material for the body 12 is 2WLJP 3.6 mil white laser jet polyester multi-purpose sheet for both laser and ink jet printing available from Green Bay Packaging. The smooth surface of 2WLJP allows graphics to really stand out on both black and white, and color printers. It should be noted, however, that other polyester, polypropylene, plastic films or fibered paper can be used. A polyester film, such as Technicote's item 83534, could be used for example.

The body 12 of the match patch 10 has two surfaces 12A, 12B. A first, upper surface 12A is directly printable. A second, lower surface 12B is provided with an adhesive layer 13 to enable the body 12 to be readily secured to the surface to be repaired. For convenience, an easily removable adhesive backing 14 is also provided, in physical communication with the adhesive layer 13 on the second surface 12B, to prevent unwanted adhesion to other surfaces.

The upper surface 12A can also be embossed to provide a surface texture that matches the surrounding surface textures. Embossing can be done by applying pressure on the body 12, by running through a press with the desired patterned tool, onto the upper surface 12A of the body 12. A match patch 10 having a smooth upper surface 12A can also be provided for use in repairing surfaces that have a non-textured surface. Preferably, a package of match patches or surface repair kit presented for commercial sale includes match patch 10 having several different sizes to allow selection of the size that best matches the surrounding surface area.

As can be seen from FIG. 1A, the match patch according to the first embodiment also preferably includes a “pinked” or feathered uneven or jagged edge 16 around the perimeter of the match patch. Feathered uneven or jagged edges 16 are desirable when repairing holes, tears or cracks in any surface, especially when it has a textured surface, because the feathered uneven, jagged edge enables the match patch to mate more easily with and blend into the surrounding surface. Specifically, for textured surfaces, the jagged edge 16 allows the serrations along the edge of the match patch to slip in between protrusions of the surrounding texture and the resulting repaired area is therefore less conspicuous. Even for smooth surfaces, however, the jagged edge breaks up the outline of the match patch and makes it more difficult to discern the repaired area.

Other features of this embodiment also make areas repaired with less conspicuous. For instance, the match patch 10 of this embodiment is thin and does not require the application of a curable repair compound. Accordingly, the match patch forms a tough diaphragm over the crack, tear or hole that is thin enough that the repair is substantially flush with the surrounding area. It is therefore more difficult to identify the repaired area after the repair is completed than with conventional repaired areas that tend to protrude noticeably from the surrounding surface.

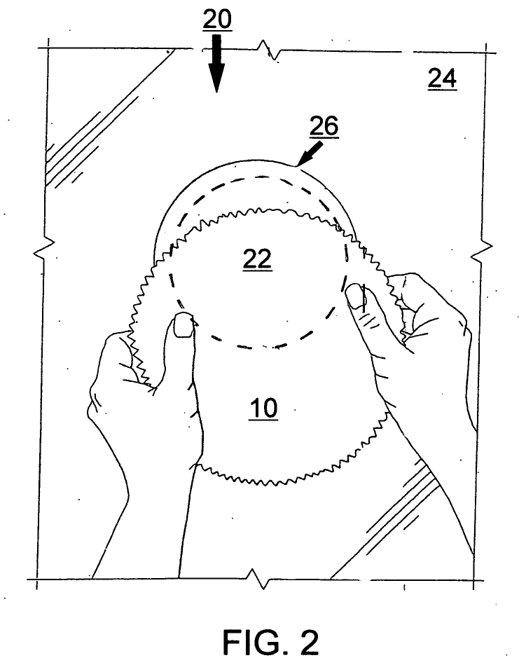

Referring now to FIG. 2, a method of repairing a hole using a match patch 10 as described with reference to FIG. IA will now be explained. FIG. 2 is a schematic perspective view of a repair area 20. A method of repairing a hole 22 on a surface 24 according to this embodiment begins by selecting a match patch 10 of an appropriate size. Various sizes and shapes can be provided, with a preferred range of sizes from approximately 0.1 inches (2.5 mm) to 7.0 inches (17.8 cm). Providing various size match patches allows the repair of many different size repairs. However a match patch 10 can also be cut to any desired shape too.

The surface 24 surrounding the hole 22 is cleaned to ensure good adhesion with the match 10. Any rough or uneven edges protruding from the damaged area above the plane of the repair surface 24 are removed to allow the match patch 10 to lie flush with the surface 24. The adhesive backing 14 is removed from the match patch 10 and the match patch 10 is then centered over the hole 22 and secured to the surface 24. Any air trapped under the margins of the match patch 10 is pressed out from the edges 16 of the match patch 10 without placing any force on the center portion of the match patch 10 in order to avoid the damaged (hole) area 22. Once the match patch 10 has been affixed, the repair is complete, and does not require the application of a curable repair compound, sanding, or any other special treatment. Furthermore, with an image printed match patch 10, there is no need to apply anything further to the repaired area of all indoor repairs. Accordingly, the only equipment needed for repairing a damaged surface according to this method of the invention is a camera, printer, match patch 10 and a user's hands.

Because of these features, the repair method of this invention provides substantial advantages over the prior art in terms of repair time, and in terms of the number of materials and tools required to perform the repair. These additional benefits make this match patch system and method fast, convenient, and easy. Furthermore, the match patch 10 according to thus invention is strong enough to provide a durable and reliable surface repair. A still further benefit of this invention is that the resulting repair is inconspicuous, and an exact visual repair to the surrounding surface.

For larger holes (i.e., holes above about 2.5 inches), it may be desirable to place a center reinforcement 26 over the hole 22 before using the match patch 10. The center reinforcement 26 can be of any desired shape and size sufficient to adequately cover the hole and secure to the surface.

The center reinforcements can be made from a smooth substantially planer flexible material, such as a polypropylene, polyester, plastic film or fibered paper, having an adhesive attachment surface, similar to the match patch 10 of the first embodiment. A preferred center reinforcement material is fibered paper, coated with a plastic laminate, such as is conventionally used for decals. When flexible center reinforcements are used, they are simply adhered to the surface centered directly over the hole 22 before application of the match patch 10. A preferred shape for this type of center reinforcement is circular or oval with feathered edges 16, similar to the match patch 10, but without a print ready surface.

If the center reinforcement 26 is being used, a match patch 10, as described with reference to FIG. 1A, is placed over the reinforcement in the method described with reference to FIG. 2. The flexible match patch 10 can then be printed on to match the surrounding wall surface 44.

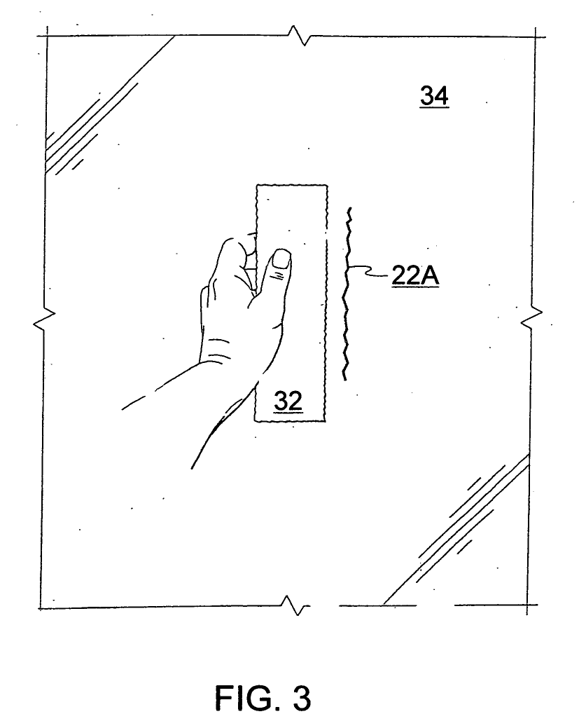

FIG. 3 illustrates a surface area 34 having a crack 22A that needs to be repaired. Referring to FIG. 3, a method of repairing a crack 22A using the match patch 32 of FIG. 3 will now be explained. A method of repairing a crack 22A proceeds by taking an image of surface area 34 that has no damage, yet has the same pattern or color as the damaged area in need of repair. Then you select (or cut) a match patch 32 of an appropriate length and width. The image is then printed onto the match patch 32. If the match patch 32 has straight edges, the edges can be pinked using pinking shears. However it may be desirable to cut along a pattern edge of the surface design. The surface 44 surrounding the crack is then cleaned to ensure good adhesion with the match patch 32. Any rough or uneven edges that protrude outwards from the damaged area 34 are removed to allow the match patch 32 to lie flush with the surrounding surface 34. The adhesive backing 14 is removed from the match patch 32 and the match patch 32 is then centered over the crack 22A and secured to the surface 34. Air is pressed out from the edges of the match patch 32. Once the match patch 32 has been affixed to the surface 34, it is repaired to an exact visual match.

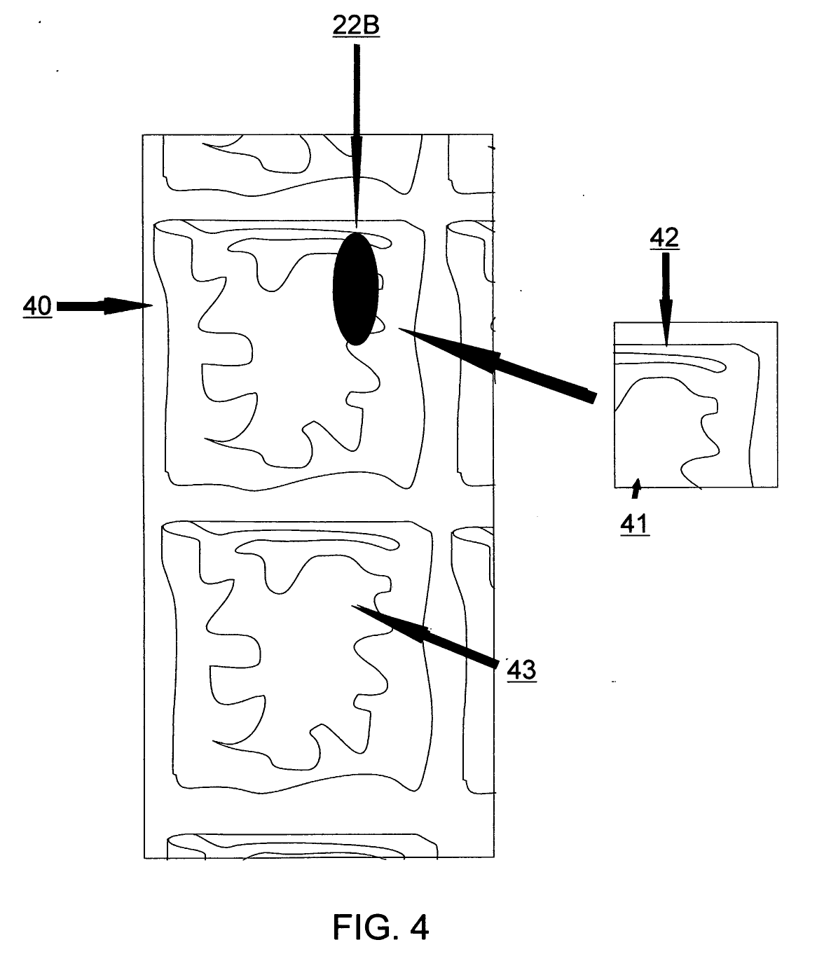

Referring now to FIG. 4 a method of repairing surface damage with a repeating pattern 40. An image is taken of a non-damaged area 43 of the surface 40. Then the image is printed on the match patch 41 using a laser, ink jet or other standard household printer. The match patch 41 can be cut along the pattern line 42 to make the repair more obscure. Once the liner (FIG. 1A number 14) is removed, the match patch can then be placed over the center of the damaged area 22B, while pressing out any air towards the edge of match patch 41. This same method will work with wood grain or any other pattern or surface design. When matching a uniform color, there would be no need to cut the match patch since there would not be a pattern to follow, and the feathered uneven jagged edges (shown in FIG. 1A number 16) will assist with visually blending the repair.

Having described and illustrated the principles of the invention in a preferred embodiment thereof, it should be apparent that the invention can be modified in arrangement and detail without departing from such principles. I claim all modifications and variations coming within the spirit and scope of the following claims.

What is claimed is:

1. A method for repairing surface damage, comprising:
taking an image of a non-damaged area of the surface needing repair;
selecting a repair patch having an outward surface adapted to be directly printable; printing the image onto the repair patch using an Ink Jet, Laser, or other household printer; applying the repair patch over the damaged area.

2. A method for repairing surface damage according to claim 1, further comprising applying a self-adhesive center reinforcement patch over the damaged area before applying the self-adhesive repair patch.

3. A method for repairing surface damage according to claim 2, wherein the center reinforcement is formed from a fibered paper, plastic, polyethylene, or polyester material.

4. A method for repairing surface damage according to claim 1, wherein the repair patch is formed from a fibered paper, plastic, polypropylene, or polyester material.

5. A method for repairing surface damage, according to claim 1, wherein the repair patch comprises an embossed upper surface, and wherein applying a repair patch over surface damage comprises:
Selecting a repair patch that is the appropriate size to cover the surface damage; and that is embossed with a pattern similar to the damaged surface area; placing it on the surface area surrounding the damaged area covering the surface damage.

6. A method for repairing surface damage, according to claim 5, wherein the embossed repair patch is formed from fibered paper, plastic, polypropylene, or polyester material, with an embossed upper surface and an adhesive located on the lower surface.

7. A method for repairing surface damage, according to claim 6, further comprising:
selecting a repair patch having an upper surface adapted to be directly printable;
placing the repair patch over the embossed patch which is between the repair patch and the damaged surface.

8. A repair method for repairing surface damage, whereby the repair patch comprises:
a substantially planar, flexible body;
an adhesive located on a lower surface of the body; and
a ready-to-print upper surface located on the body.

9. A repair method according to claim 8, wherein the ready-to-print upper surface of the repair patch body is embossed and wherein one or more edges of the body are feathered, uneven, or jagged to allow the body to more readily mate with the surrounding surface.

10. A repair method according to claim 9, wherein the repair patch body is formed from a fibered paper, plastic, polypropylene, or polyester material.
